(19) United States
(12) Patent Application Publication
(10) Pub. No.: US 2014/0365940 A1
(43) Pub. Date: Dec. 11, 2014

(54) SYSTEMS AND METHODS FOR MANIPULATING BOUNDARY CONDITIONS

(71) Applicant: SOLAR TURBINES INCORPORATED, San Diego, CA (US)

(72) Inventors: Ruford Joseph Bolchoz, III, San Diego, CA (US); Michael Dennison Fox, San Diego, CA (US); Xubin Gu, San Diego, CA (US); Hasan Nasir, San Diego, CA (US); Matthew Gregory Sutton, Phoenix, AZ (US); Elias Razinsky, San Diego, CA (US); Hee Koo Moon, San Diego, CA (US)

(21) Appl. No.: 13/913,209

(22) Filed: Jun. 7, 2013

(51) Int. Cl. G06F 3/0484

(52) U.S. Cl. CPC G06F 3/04845
USPC 715/771

(57) ABSTRACT

Systems and methods for manipulating boundary conditions are described, including rendering at least a portion of a model of a mechanical thing. The model includes mesh data and boundary condition data, which may be rendered with contour lines. User input is received indicating changing at least a segment of at least one of the contour lines. The user input may be input using a graphical user interface to produce a graphical representation of a new contour line to replace at least a segment of one of the contour lines. At least the new contour line may be outputted and/or stored as modified boundary condition data to represent the replaced segment.

### TECHNICAL FIELD

The subject matter discussed herein relates generally to computer-aided tools and, more particularly, to systems and methods for manipulating boundary conditions in a computer model of a mechanical thing.

### BACKGROUND

During the design of a mechanical unit or component with boundary conditions (e.g., boundary conditions relating to thermodynamics, flow or fluid mechanics, structural analysis, failure analysis, etc.), designers or engineers design a model of the mechanical unit and manually tune the model's boundary conditions. In the design process, manual tuning of the model's boundary conditions is likely to occur in a few stages. For example, tuning at the initial design, tuning after analysis of the design, and tuning to match test data after performing testing (e.g., with a prototype). At each stage, hours, days, or longer may be required to effectively tune a model manually.

U.S. Pat. No. 7,103,515 describes a method for automatically analyzing an article of manufacture comprising the steps of a) providing a master model and a context model specification; b) creating a context model from the master model and the context model specification; c) translating the context model into an engineering analysis model compatible with an engineering analysis program; d) executing the engineering analysis program to generate a performance estimate form the engineering analysis model; and e) optionally modifying the master model to improve the performance estimate.

The present disclosure is directed toward overcoming one or more of the problems discovered by the inventors.

### SUMMARY

The subject matter includes a method for manipulating boundary conditions, including rendering at least a portion of a model of a mechanical component. The model includes mesh data and boundary condition data, and the boundary condition data may be rendered with contour lines. User input is received indicating changing at least a segment of at least one of the contour lines. The user input may be input using a graphical user interface to produce a graphical representation of a new contour line to replace at least a segment of one of the contour lines. At least the new contour line may be outputted and/or stored as modified boundary condition data to represent the replaced segment.

In addition to the method above, the implementations may include a device, a system, and/or a computer-readable medium, but are not limited thereto.

### BRIEF DESCRIPTION OF THE DRAWINGS

FIG. 1 is a diagram of an example design process.

FIG. 2 is a diagram of an example of another design process.

FIG. 3 is a part of a screen shot of an example graphical user interface.

FIG. 4 is a part of another screen shot of the example graphical user interface.

FIG. 5 is a part of another screen shot of the example graphical user interface.

FIG. 6 is a flow diagram of an example of a process implementation.

FIG. 7 is a block diagram of an example computing environment with an example computing device suitable for use in some example implementations.

### DETAILED DESCRIPTION

The systems and methods disclosed herein include a computer implemented design tool for manipulating boundary conditions such as thermal boundary conditions. Embodiments include rendering at least a portion of a model of a mechanical thing (e.g., a blade, nozzle, vane, disk, etc. for a gas turbine engine). The model includes mesh data and boundary condition data, which may be rendered with contour lines. User input is received indicating changing at least a segment of at least one of the contour lines. The user input may be input using a graphical user interface to produce a graphical representation of a new contour line to replace at least a segment of one of the contour lines. At least the new contour line may be outputted and/or stored as modified boundary condition data to represent the replaced segment.

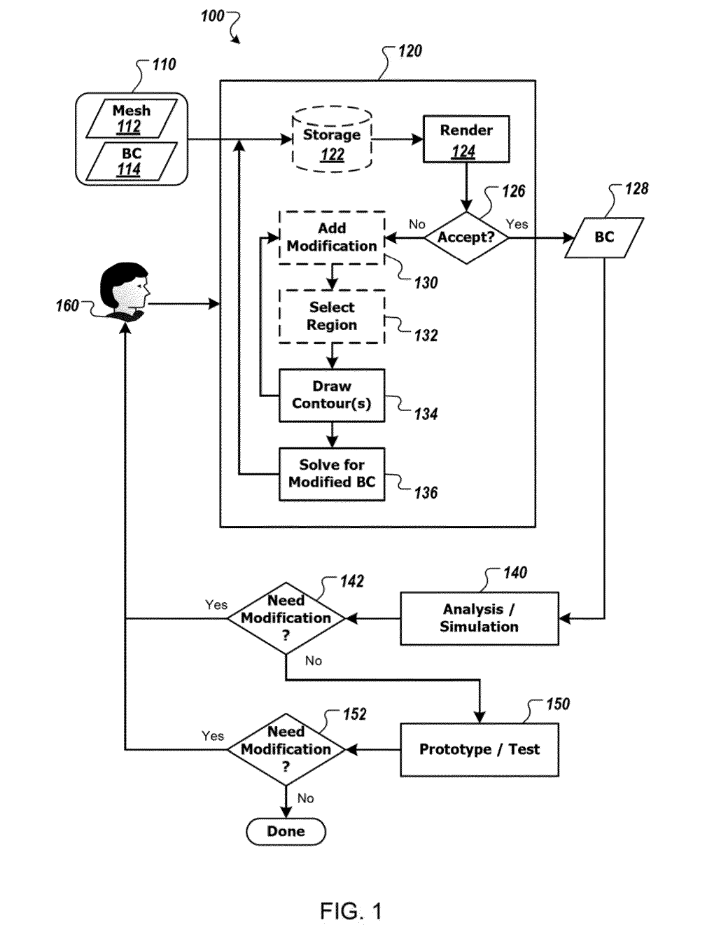

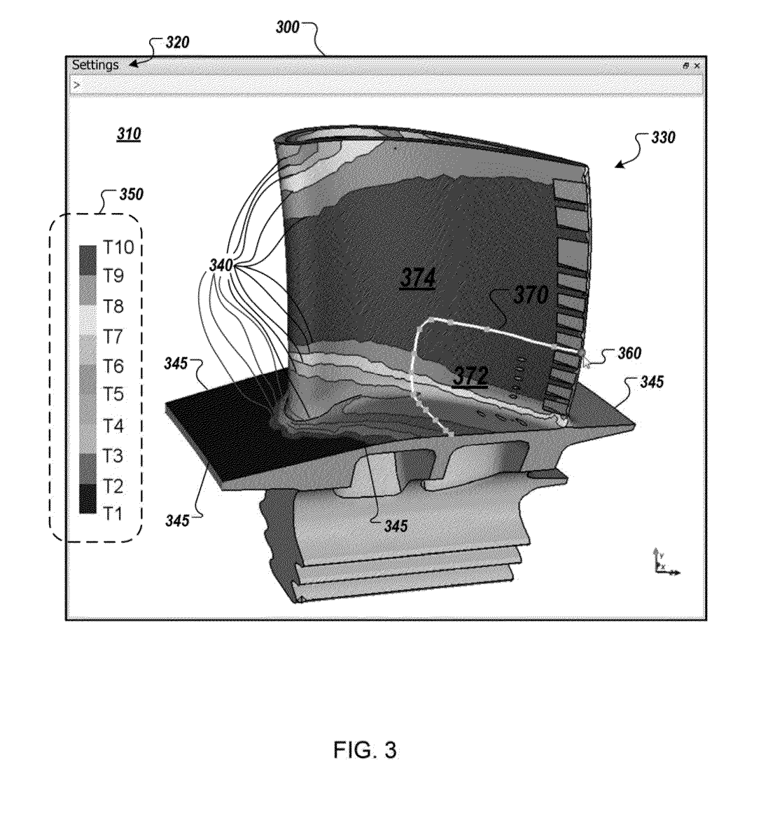

FIG. 1 is a diagram of an example design process. Design process 100 shows, for example, a model 110 of a mechanical thing, item, component, part, piece, or unit, which may be inputted to or retrieved by tool 120. User 160 may use tool 120 to modify model 110, which may be rendered and/or shown as object 330 (FIG. 3) and/or modify at least some of the boundary condition data (e.g., BC 114 or 128).

Model 110 may be any model (e.g., a finite element model) usable in designing a mechanical item. Model 110 may be a model that covers at least a part of an airfoil of a gas turbine. Model 110 may include, for example, mesh data 112 and boundary condition data, which may be referred to as boundary conditions (BC) 114 (e.g., thermal boundary conditions). Model 110 may include other data (not shown). If need to, tool 120 may convert model 110 from one format (e.g., finite difference or boundary element format) to another format (e.g., finite element format). Tool 120 may be any tool (e.g., a computer-aided tool) used in design process 100. Tool 120 may store model 110 in storage 122 before or after rendering the model 110 (e.g., on a display, as that of FIG. 3, 4, or 5). A designer (e.g., user 160) may view the rendered model (e.g., object 330, FIG. 3, described below) and make a decision 126 to accept or not accept the model.

If the model is not accepted, user 160 may modify the model graphically, which is described FIGS. 3-5 below. For example, user 160 may, depending on implementations of tool 120, create a modification group or layer, at block 130, to associate with one or more modifications. With modification groups or layers, the effect of one or more modification groups or layers may be activated or deactivated (e.g., applied) on model 110.

Modifications of a model may be applied to the entire model or a portion of the model. For example, user 160 may carefully perform the modification graphically on a portion of the model to prevent or minimize affecting other portions. In some implementations, a mechanism is provided to allow user 160 to select a region at block 132. With a region selected, modification of the model is confined to the selected region. Areas outside the region are not affected.

With a modification group created and/or a region selected, user 160 may perform design modification of model 110 by, for example, graphically drawing, at block 134, one or more contours (e.g., contour lines) that represent at least some of the desired boundary conditions of model 110 (e.g., to modify BC 114). When user 160 is satisfied with the drawn contour lines, user 160 sees the model rendered with the drawn contour line by instructing the tool to apply them (e.g., clicking on an “Apply” button, not shown). User 160 may create one or more additional modification groups or layers using blocks 130 to 134.

Before rendering, tool 120 solves for the modified boundary conditions at block 136 based on the drawn contour lines. In some implementations with modification groups, the modified boundary conditions are based on all the drawn contour lines that are associated with the current active modification groups or layers. For example, modification group A may contains one contour line A1, modification group B may contains one contour line B1, and modification group c may contains three contour lines C1, C2, and C3. If groups A and C are activated (e.g., active modification groups), tool 120 solves for the modified boundary conditions based on the desired contour lines A1, C1, C2, and C3 (i.e., B1 is excluded).

If user 160 wants to see the model rendered with different modification groups or layers, the user may activate those groups, arrange them in the order that the groups are to be applied (e.g., arranging group A above group B if group A should be applied on top of group B) before pressing, for example, the “Apply” button. The model or at least the drawn contour lines or groups of drawn contour lines may be stored in storage 122 before or after rendering at block 124.

If the decision 126 is that the model is accepted, tool 120 may produce boundary condition data (BC) 128 (e.g., including the activated drawn contour lines or groups of drawn contour lines). In some implementations, other data (e.g., mesh data) of the model may also be produced. Tool 120 may produce output 128 (as an output file and/or stored in a storage), which may be used in other tools 140 and/or 150 in design process 100 and/or elsewhere (not shown).

Tool 120 or at least some of its functions may be implemented using one or more computing devices. For example, the functions may be implemented as one or more methods on the computing devices using software, hardware, and/or both. At least some of the functions may be implemented using executable code (e.g., software) stored on computer media. In some implementations, tool 120 may perform other functions and/or operations not described above.

The model with BC 128 and mesh 112 may be analyzed using a design analysis and/or simulation tool 140 (e.g., a finite element analysis tool, such as one created by ANSYS® or one created by COMSOL Multiphysics®, etc.). If the results of the analysis indicate that BC 128 of the model needs further modification, at decision block 142, tool 120 may be used again and again (e.g., from blocks 120 to 140) until the decision at block 142 is “No.”

Optionally, the model with at least BC 128 and mesh 112 may be used to produce one or more prototypes and perform testing with the prototypes at block 150. If the test data or test results indicate that the model (e.g., BC 128) needs further modification, at decision block 152, tool 120 may be used to graphically modify the boundary conditions again and again (e.g., from blocks 120 to 150) until the decision at block 152 is “No.” At which point, the design of model 110 (e.g., the creation of a calibrated model) for a mechanical component if complete. If needed, for any reasons, a complete model may still be changed using tool 120.

Model 110, storage 122, and BC 128 are illustrated as shown solely to aid the description of design process 100. In implementations, storage 122 may be one or more storage devices connected on a network, to which tools 120, analysis/simulation tool 140, and/or apparatus (e.g., computer devices) used to produce prototypes and/or testing at block 150 are also connected. Tool 120 may retrieve model 110 or a portion of it from a networked storage 122 and produce and store BC 128 on storage 122. Analysis/simulation tool 140 may retrieve a modified version of model 110 (e.g., one with mesh 112 and BC 128) from storage 122 to perform analysis. Similarly, computing devices used at block 150 may retrieve a modified version of model 110 from storage 122 to produce one or more prototypes and/or perform testing.

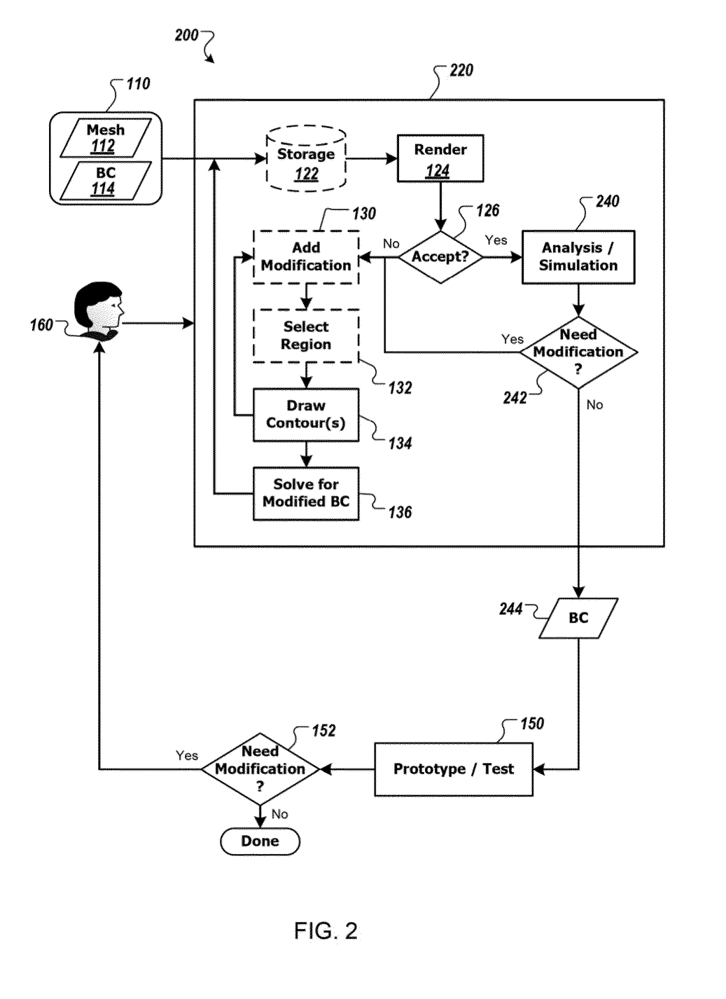

FIG. 2 is a diagram of an example of another design process. Design process 200 is shown using tool 220 which includes the functions and/or operations of tools 120 and 140 (FIG. 1). For example, tool 220 may be a workbench type of tool (e.g., ANSYS® Workbench) that includes or integrates the functions of blocks 130-136 for creating modified contour lines and the analysis and/or simulation functions represented by block 240. The decision block 242 is equivalent to decision block 142 (FIG. 1). When modification is not needed, at decision block 242, BC 244, which may be stored to and accessed from a networked storage 122, may be used to produce one or more prototypes and perform testing with the prototypes at block 150.

Some design processes (not shown) may use a workbench type of design tool or system that may integrate the functions for creating model 110, functions of tool 120, and functions of one or more apparatuses referred to in block prototype/test 150.

FIG. 3 is a part of a screen shot of an example graphical user interface (GUI) of tool 120 to tool 220. Window 300 may be a window or a part of multiple windows or panels shown on a display (e.g., a screen or monitor). Window 300, which may be referred to as GUI 300, may include a main panel 310 and settings 320 (e.g., for setting of options, preferences, profiles, configuration, customization, etc. of tool 120 (FIG. 1) or tool 220 (FIG. 2). Model 110 (FIG. 1) may be rendered on panel 310 as an object 330. Mesh 112 of model 110 may be used to render the structure of object 330, which may be a portion of an airfoil, nozzle, disk, for example.

Boundary condition data BC 114 of model 110 may be rendered using contour lines 340. A contour line represents a boundary between an area on one side of the contour line and another area on the other side of the contour line. The area represents a portion of the boundary condition data that is equal to or above a value (one of T1 to T10). The other area represents a second portion of the boundary condition data that is less than the value. The boundary or contour line represents the value.

Note that there are contour lines on the top portion of object 330. To minimize cluttering FIG. 3, the contour lines on the top portion of object 330 are not indicated with reference numeral. The description of contour lines 340 (below) apply to the contour lines on the top portion (e.g., a user may select, draw, redraw, modify them). The term “contour lines” or “contour lines 340” used in association with object 330 refer to contour lines 340 and those on the top portion of object 330.

Lines 345 show where boundary condition data are rendered (e.g., above lines 345) based on model 110 and object 330. Legends 350 show the legends of contour lines 340. Legends 350 show values (e.g., T1-T10) that are associated with the visual scale (e.g., colors, shades of gray, crosshatched patterns, etc.) used on object 330. Values T1-T10 are place holders shown for describing object 330. In actual usage, T1-T10 are threshold values (e.g., boundary conditions) of the different shades used. For example, if object 330 is a component that involves fluid or air flow, T1-T10 maybe values for flow speeds, directions, pressure, etc. associated with fluid or flow dynamics. If object 330 is a component that involves pressure or stress, T1-T10 maybe stress or pressure values. If object 330 is a component that involves convection of heat (e.g., an airfoil, blade, or vane of a gas turbine engine), T1-T10 maybe temperature values in the range of temperatures object 330 may experience. For example, T1-T10 may be gas temperatures or gas temperatures accounting for heat transfer coefficient.

The rendering function of block 124 (FIG. 1) may rendered object 330 with contour lines 340 and legends 350. User 160, based at least on the rendering of object 330, may decide whether the boundary conditions (shown as contour lines) of object 330 are acceptable. If not and/or user 160 wants to modify some part of the contour lines, user 160 may create a modification group or layer (130, FIG. 1, but not shown in FIG. 3).

To input or draw one or more contour lines, user 160 may use a pointing device (e.g., pointer 360 controlled by a mouse, input pad, touch pad, etc.) to interact with GUI 300. GUI 300 may be implemented to allow user 160 to zoom in and out to view and/or manipulate object 330 under different zoom levels. Object 330 may be rotated with respect to the x-axis, y-axis, and/or z-axis.

In some implementations, user 160 may draw or otherwise create the boundary 370 of a region 372, in which contour lines may be modified. Area 374 outside of region boundary line 370 is unaffected but any modification input. Region boundary 370 may be created in any manner. For example, region boundary 370 may be created by drawing line segments (e.g., as shown with the dots on the boundary). User 160 may create boundary 370 using a lasso tool (not shown), a shape tool (e.g., a rectangle, or circular shape tool, not shown), etc. Boundary 370 may be reshaped and/or resized. When user 160 is satisfied with region 372 defined by boundary 370, user 160 may start drawing one or more contour lines in region 372 to modify the existing contour line segments enclosed in region 372.

In some implementations, region boundary 370 and region 372 may not be implemented or available. Even if they are available for use, user 160 may not or does not need to use them. For example, user 160 is confident that he or she can modify the right portion of object 330 without using or defining region 372 (e.g., without drawing region boundary 370).

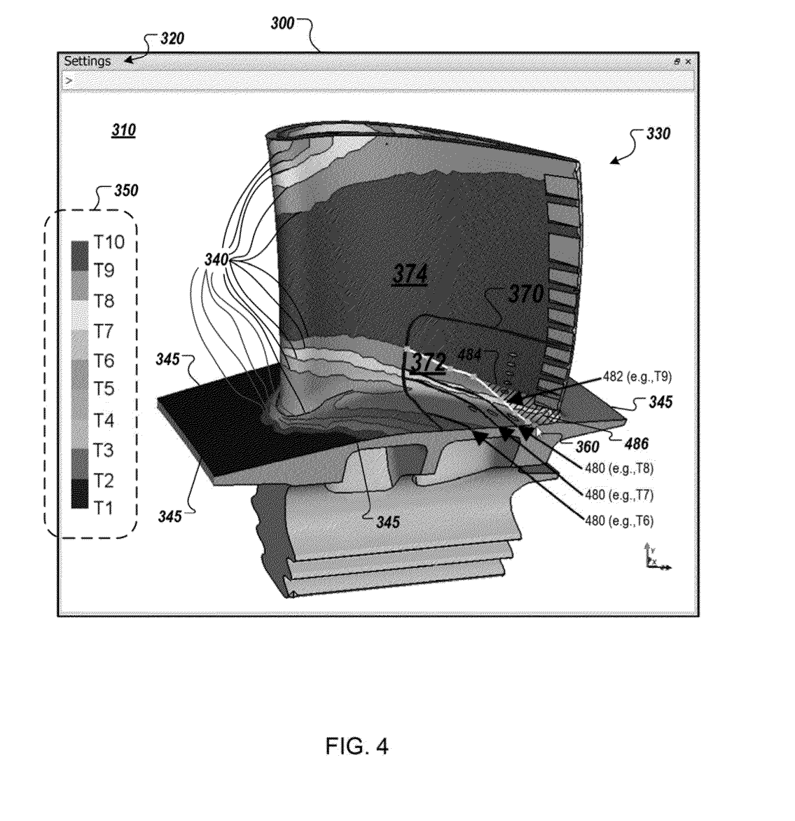

FIG. 4 is a part of another screen shot of the example graphical user interface. The screen shot of FIG. 4 shows that user 160 graphically draws (e.g., using pointer 360) contour lines 480 and 482 (new contour lines or line segments). New contour lines 480 are, for example, new segments of some T6-T8 contour lines (e.g., contour lines representing values T6-T8), and new contour line 482 is also shown as, for example, a new segment of a T9 contour line (e.g., a contour line representing the value T9). New contour line 482 may be shown differently from contour lines 480 to illustrated that, for example, contour line 482 is newly drawn or is activated in an edit mode (e.g., can be changed). New contour lines 480 and 482 may be drawn in any ways or manners known in the field of GUI. A new contour line 482 or 480 may be drawn from any point and/or to any point of an existing contour line. A new contour line 482 or 480 may be shorter or longer than an existing contour line for replacing a segment or the entire length of an existing contour line.

New contour lines 480 and 482 (referred to as “drawn contour lines” above in the description of FIG. 1) are drawn to show the desire modification of some of the contour lines (e.g., T6-T9) in region 372. For example, new contour line 482 (shown in white) is drawn to show that user 160 wants to change a segment or portion of an existing contour line 484 to the new contour line 482. The change portion 486 is shown with lines crossing/connecting the new contour line 482 and the existing contour line 484, with the former intended by user 160 to replace the latter.

New contour lines 480 and 482 define new areas (referred to as areas A1-A5 for discussion). Tool 120 identifies or determines areas A1-A5 when solving for the modified boundary conditions in these areas. A1 is enclosed by lines 482 (T9), 345, and 370. A2 is enclosed by lines T9, 370, T8, and 345. A3 is enclosed by lines T8, 370, T7, and 345. A4 is enclosed by lines T7, 370, T6, and 345. And A5 is enclosed by lines T6, 370, and 345. When user 160 is satisfied with, for example, the T6-T9 lines, user 160 may then request tool 120 to solve for the modified boundary conditions by, for example clicking on an “Apply” button (not shown). Tool 120 then replaces data representing the areas A1-A5 with data based on the new contour lines 480 and 482.

An example implementation may include using a conduction solver which, for example, sets up a finite element conduction problem containing the elements (e.g., boundary condition data) inside region 372. Outside boundary 370, the original temperatures are fixed (e.g., boundary conditions remain unchanged). New contour lines 480 and 482 may be treated by the conduction solver as a heat source boundary condition (e.g., like a thermostat) where energy is inserted or removed in order to achieve the user-specified temperatures indicated by the new contour lines 480 and 482. Influence of the new contour lines 480 and 482 can be increased or decreased using, for example, a “thermostat gain” control.

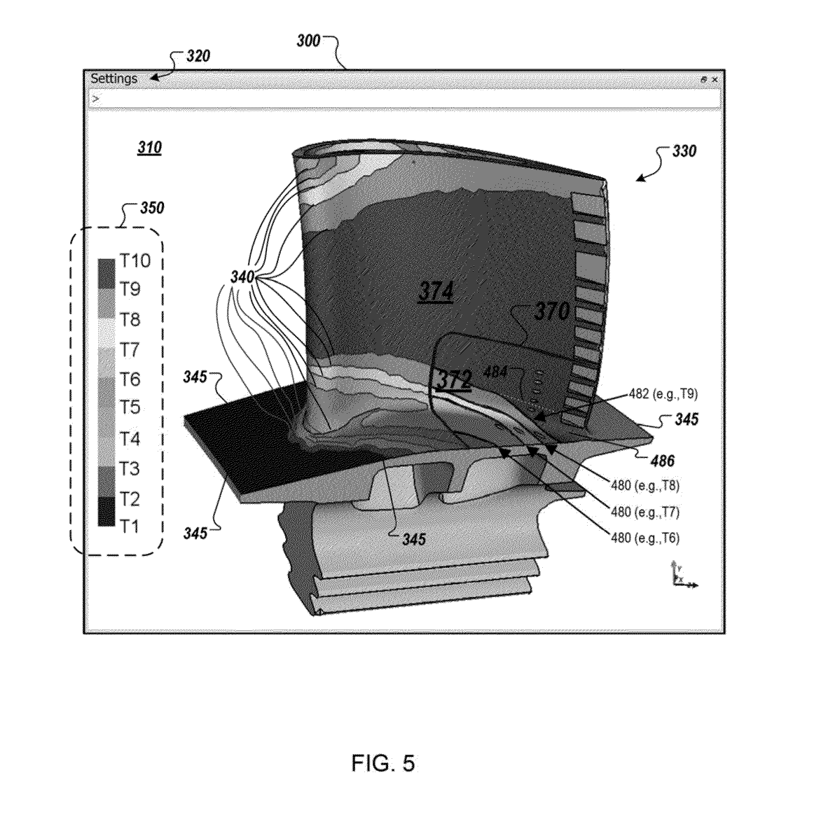

FIG. 5 is a part of another screen shot of the example graphical user interface. The screen shot of FIG. 5 shows that areas A1-A5 have been modified to reflex that the new contour lines 480 and 482 are now part of the contour lines of object 330. If the contour lines, including contour lines 480 and 482, are accepted by user 160, user 160 may save and/or output the modified design of object 330. The modified design of model 110 may include at least the new contour lines as modified boundary condition data (e.g., BC 128, FIG. 1).

As described in FIG. 1, user 160 may create additional contour lines modification after analysis, simulation, prototyping, and/or testing (e.g., using GUI 300, FIGS. 3-5).

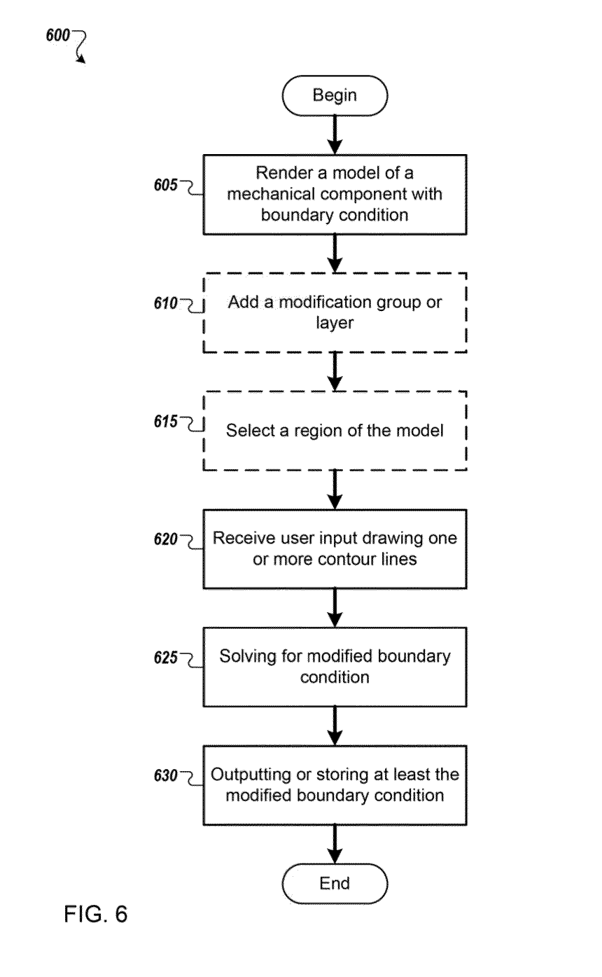

FIG. 6 is a flow diagram of an example of a process implementation. Process 600 is shown starting, at block 605, with tool 120, for example, renders at least a portion of model 110 of a mechanical component (e.g., airfoil of a gas turbine). Model 110 includes, for example, mesh data 112 and boundary condition data 114. Boundary condition data may be rendered with contour lines.

At block 610, a modification group or layer may be created. The operations in this and the next block are optional and depend on implementations. At block 615, a region of the rendered model may be selected, defined, drawn, or otherwise indicated (e.g., graphically).

At block 620, tool 120, for example, receives input from user 160 indicating changing at least a segment of at least one of the contour lines. The input may be a graphical representation of one or more new contour lines to replace segments or portions of existing contour lines. Each one of the new contour lines has at least one point not on the segments or portions of the existing contour lines.

When user 160 is done drawing the new contour lines, he or she may issue a command (e.g., press an “Apply” or “Solve” button) to tool 120 to solve for the modified boundary condition based on the new contour lines. For example, boundary condition representing an area between an existing contour line and a new replacement contour line may be replaced with data based on the new contour line. The modified boundary condition data may be saved, stored, and/or outputted (e.g., with or without other boundary condition data and/or data representing the mesh).

In some examples, process 600 may be implemented with different, fewer, or more blocks. Process 600 may be implemented as computer executable instructions, which can be stored on a medium, loaded onto one or more processors of one or more computing devices, and executed as a computer-implemented method.

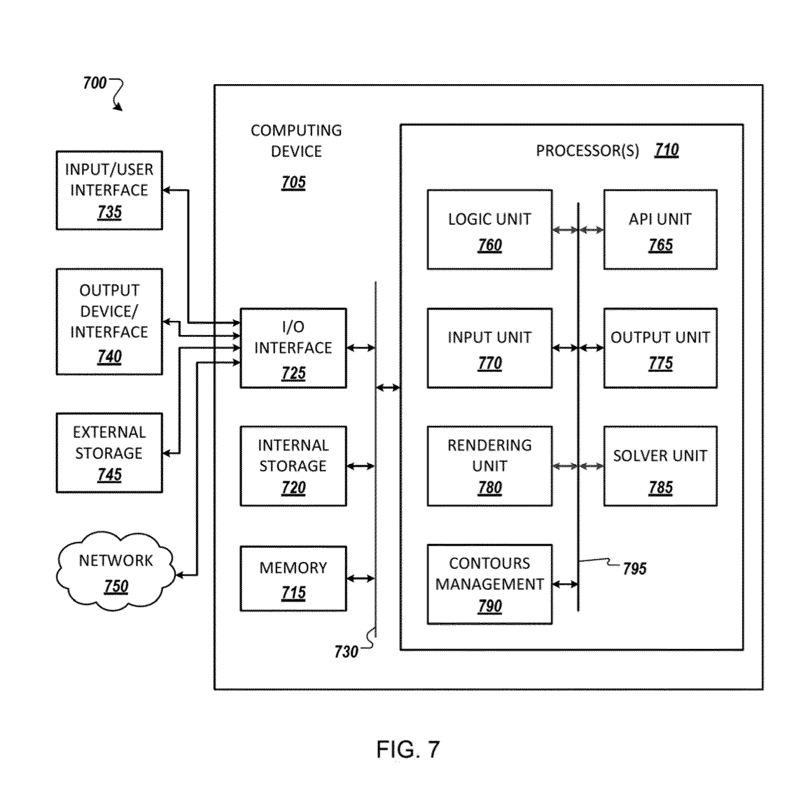

FIG. 7 is a block diagram of an example computing environment with an example computing device suitable for use in some example implementations. Computing device 705 in computing environment 700 can include one or more processing units, cores, or processors 710, memory 715 (e.g., RAM, ROM, and/or the like), internal storage 720 (e.g., magnetic, optical, solid state storage, and/or organic), and/or I/O interface 725, any of which can be coupled on a communication mechanism or bus 730 for communicating information or embedded in the computing device 705.

Computing device 705 can be communicatively coupled to input/user interface 735 and output device/interface 740. Either one or both of input/user interface 735 and output device/interface 740 can be a wired or wireless interface and can be detachable. Input/user interface 735 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 740 may include a display, television, monitor, printer, speaker, braille, or the like. In some example implementations, input/user interface 735 and output device/interface 740 can be embedded with or physically coupled to the computing device 705. In other example implementations, other computing devices may function as or provide the functions of input/user interface 735 and output device/interface 740 for a computing device 705.

Computing device 705 can be communicatively coupled (e.g., via I/O interface 725) to external storage 745 and network 750 for communicating with any number of networked components, devices, and systems, including one or more computing devices of the same or different configuration. Computing device 705 or any connected computing device can be functioning as, providing services of, or referred to as a server, client, thin server, general machine, special-purpose machine, or another label.

I/O interface 725 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, satellite network, and the like).

Computing device 705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 710 can execute under any operating system (OS) (not shown), in a native or virtual environment. One or more applications can be deployed that include logic unit 760, application programming interface (API) unit 765, input unit 770, output unit 775, rendering unit 780, solver unit 785, contours management 790, and inter-unit communication mechanism 795 for the different units to communicate with each other, with the OS, and with other applications (not shown). For example, rendering unit 780, solver unit 785, and contours management 790 may implement one or more processes and/or user interface shown in FIGS. 1-6. The described units and elements can be varied in design, function, configuration, or implementation and are not limited to the descriptions provided.

In some example implementations, when information or an execution instruction is received by API unit 765, it may be communicated to one or more other units (e.g., logic unit 760, input unit 770, output unit 775, rendering unit 780, solver unit 785, and contours management 790). For example, after rendering unit 780 renders model 110 as object 330, user 160 may draw one or more contour lines. The user's input drawing the contour lines, which indicates changing at least a segment of at least one of the existing contour lines, is received by input unit 770 (receiving means), which communicates the input data to rendering unit 780 to render the newly drawn contour lines. Input unit 770 may also communicate the user input to contours management 790. When user 160 is done drawing (e.g., based on another indication, such as the activation of an “Apply” button received by input unit 770 and determined by logic unit 760), solver unit 785 may be instructed (e.g., by logic unit 760 or API unit 765) to solve for new boundary condition based on the newly drawn contour lines. Output unit 775 may produce output 128, which contains at least the drawn contour lines as modified boundary condition data.

In some instances, logic unit 760 may be configured to control the information flow among the units and direct the services provided by API unit 765, input unit 770, output unit 775, rendering unit 780, solver unit 785, and contours management 790 in some example implementations described above. For example, the flow of one or more processes or implementations may be controlled by logic unit 760 alone or in conjunction with API unit 765.

### INDUSTRIAL APPLICABILITY

The subject matter described herein can be applicable in designing any mechanical thing that may involve boundary conditions. For example, the subject matter can be implemented in a standalone or integrated computer-aided tool and/or a computing device usable in designing a mechanical component that experiences air flow, fluid flow, heat, cold, stress, pressure, force, etc. One of the numerous possible examples is a gas turbine, which involves many components that may involve or experience boundary conditions. For example, an airfoil of a turbine blade may experience thermal boundary conditions from structural temperatures and/or surface temperatures. The thermal boundary conditions may be based on gas temperatures, based on both gas temperatures and heat transfer coefficient, and/or other factors (convection and/or radiation factors).

The subject matter described herein enable designers or users to graphically and visually modify boundary conditions of models of a mechanical items or components. The graphical/visual process (e.g., design process 100, FIG. 1) saves design effort and time. In some cases, the time saved may be about 90% or higher compared to the manual process of manipulation of boundary conditions (e.g., 10 hours in a manual process vs. 1 hour in a graphical/visual process). In addition to saving time and effort from, the graphical/visual process (e.g., design process 100, FIG. 1) also produce better quality models.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A computer-implemented method, comprising:
rendering at least a portion of a model of a mechanical component, the model comprises mesh data and boundary condition data, where the boundary condition data are rendered with contour lines;
receiving user input indicating changing at least a segment of at least one of the contour lines, the user input comprises a graphical representation of a new contour line to replace the at least the segment, where the new contour line has at least one point not on the at least the segment; and
outputting at least the new contour line as modified boundary condition data to represent the at least the segment.

2. The method of claim 1, wherein a contour line of the contour lines represents a boundary between a first area on a first side of the contour line and a second area on a second side of the contour line, where the first area represents a first portion of the boundary condition data that is equal to or above a value, the second area represent a second portion of the boundary condition data that is less than the value, and the boundary represents the value.

3. The method of claim 1, further comprising, before the outputting, creating the modified boundary condition data using at least the new contour line and the at least the segment.

4. The method of claim 3, wherein the creating the modified boundary condition data comprises:
determining an area bounded by the new contour line and the at least the segment; and
replacing data representing the area with data based on the new contour line.

5. The method of claim 1, further comprising, before receiving the user input, receiving another user input defining a region of the portion of the model, wherein the region allows a portion of the boundary condition data that represents the region to be changed by the user input.

6. The method of claim 1, wherein the new contour line is grouped in a modification group, which is different from another modification group that grouped at least another contour line, and the modification group and the another modification group are configured to be activated individually or in combination to create the modified boundary condition data.

7. The method of claim 1, wherein the model of a mechanical component is a finite element model.

8. A mechanical component designed using the method of claim 1.

9. The mechanical component of claim 8, wherein the mechanical component is a blade or vane of a gas turbine engine.

10. The method of claim 1, wherein the boundary condition data and modified boundary condition data comprise thermal boundary condition data.

11. At least one computing device comprising storage and a processor, the at least one computing device comprises:
a rendering unit for rendering at least a portion of a model of a mechanical component, the model comprises mesh data and boundary condition data, where the boundary condition data are rendered with contour lines;
receiving means for receiving user input indicating changing at least a segment of at least one of the contour lines, the user input comprises a graphical representation of a new contour line to replace the at least the segment, where the new contour line has at least one point not on the at least the segment; and
an output unit for outputting at least the new contour line as modified boundary condition data to represent the at least the segment.

12. The at least one computing device of claim 11, wherein a contour line of the contour lines represents a boundary between a first area on a first side of the contour line and a second area on a second side of the contour line, where the first area represents a first portion of the boundary condition data that is equal to or above a value, the second area represent a second portion of the boundary condition data that is less than the value, and the boundary represents the value.

13. A mechanical component designed using the at least one computing device of claim 11.

14. The mechanical component of claim 13, wherein the mechanical component is a blade or vane of a gas turbine engine.

15. The at least one computing device of claim 11, wherein the modified boundary condition data comprise thermal boundary condition data created by replacing data representing an area bounded by the new contour line and the at least the segment with data based on the new contour line.

16. A non-transitory computer readable medium having stored therein computer executable instructions for:
rendering at least a portion of a model of a mechanical component, the model comprises mesh data and boundary condition data, where the boundary condition data are rendered with contour lines;
receiving user input indicating changing at least a segment of at least one of the contour lines, the user input comprises a graphical representation of a new contour line to replace the at least the segment, where the new contour line has at least one point not on the at least the segment; and
outputting at least the new contour line as modified boundary condition data to represent the at least the segment.

17. The computer readable medium of claim 16, wherein the new contour line is grouped in a modification group, which is different from another modification group that grouped at least another contour line, and the modification group and the another modification group are configured to be activated individually or in combination to create the modified boundary condition data.

18. A mechanical component designed using the computer readable medium of claim 16.

19. The mechanical component of claim 18, wherein the mechanical component is a blade or vane of a gas turbine engine.

20. The computer readable medium of claim 16, wherein the boundary condition data and modified boundary condition data comprise thermal boundary condition data.
